(19) United States
(12) Patent Application Publication
(10) Pub. No.: US 2009/0286499 A1
(43) Pub. Date: Nov. 19, 2009

(54) HIGH DYNAMIC RANGE RECEIVER

(75) Inventors: Ashok Kumar MARATH, Singapore (SG); Naveen Altaf Ahmed SYED, Singapore (SG)

Correspondence Address: CONLEY ROSE, P.C.;David A. Rose, P. O. BOX 3267, HOUSTON, TX, 77253-3267, US

(73) Assignee: AGENCY FOR SCIENCE TECHNOLOGY AND RESEARCH

(21) Appl. No.: 12/469,307

(22) Filed: May 20, 2009

Related U.S. Application Data
(63) Continuation of application No. 10/499,285, filed on Aug. 3, 2007, now abandoned.

(51) Int. Cl. H04B 1/12

(52) U.S. Cl. 455/311

(57) ABSTRACT

A multimode receiver/down converter architecture for use with narrow channel bandwidth and channel bandwidth system signals is described. Interfering signals for a selected narrowband channel are attenuated using a method that reduces the dynamic range of the signal for further processing. The proposed method can be used with a receiver architecture, such as Direct-Conversion, low IF, Super heterodyne, and the like. The downconverted signal is split into two paths. One signal path is delayed and subtracted from the signal from the other path. By controlling the delay value, the interference signals at a given offset are attenuated. Based on the chosen architecture, the desired signal is placed so that the signal undergoes minimal distortion.

### FIELD OF THE INVENTION

The present invention relates to signal processing systems and more particularly to improved techniques to reduce interference in radio communication systems.

### BACKGROUND

Recently, receivers have been needed that can operate in different communication networks. Existing and proposed communication networks differ in many ways, including operating on different channel bandwidth specifications and different access technologies for multiple users. The differing processing requirements for modem and protocol functions can be realised with programmable components. These multi-system receivers are usually implemented to cater for the wider bandwidth systems hence there is a need for the front end to handle more number of narrow bandwidth channels falling within the wide channel bandwidth of the wideband system. This could be avoided if programmable bandwidth filters are used to do signal channellization in the front end. But programmable bandwidth filters are hard to realize and using multiple filters catering to different bandwidths will make the system bulk and lossy.

FIG. 1 illustrates a simple receiver architecture 100 for these kind of receivers. The receiver architecture 100 includes an antenna 110, a radio frequency (RF) processing and down conversion circuit 110, an analogue-to-digital conversion (ADC) circuit 120, and a baseband processing and data demodulation circuit 130, which are sequentially connected in the foregoing order. Such a receiver architecture 100 requires a signal to be digitised, before different processing can be applied as per modem standards. With different channel bandwidths, the RF processing circuit 110 must be able to handle high dynamic range signals, since multiple channels of a narrow bandwidth system can fit into one channel's bandwidth of a higher bandwidth system. To meet the blocking signal requirements of narrow bandwidth systems that fall within a single wider channel bandwidth, the receiver architecture 100 requires a baseband/intermediate frequency (IF) filter with a bandwidth that can be programmed, or different filters with different bandwidths switched one at a time. This can also be solved by precision filtering in the digital domain, which will require high dynamic range digitizers 120 or much higher oversampling ratios to digitize the required signal along with the blocking signals.

The requirement on ADCs or A/Ds 120 can be reduced by considering the blocking signals as noise overlapping with the required information signal and cancelling the noise out in one of the ways mentioned below. This noise signal can be cancelled out by generating a replica of the blocking signals using prediction techniques and a delayed version of the noise mixed incoming signal and adding in an out-of-phase signal with the incoming signal, as described in U.S. Pat. No. 5,903,819 issued to Romesburg on 11 May 1999. Disadvantageously, this type of scheme requires many components to implement and greater processing power to predict the noise signal at IF frequencies. The validity of the replica sample values depends on how fast the noise estimator works and the accuracy of the estimator.

In some schemes as described in U.S. Pat. No. 3,938,153 issued to Lewis et al. on 10 Feb. 1976 and U.S. Pat. No. 3,938,154 issued to Lewis on 10 Feb. 1976, the interfering blocking signals can be isolated using several filters with different bandwidths and/or downconversion using multiple local oscillators and subtracting from the noise mixed downconverted signal. The drawback of this type of scheme is having a number of local oscillators (LOs), mixers, bandpass filters, and subtractors.

Few implementations for the cancellation of blocking signals have multiple antennas and perform some kind of beam steering to attenuate the interfering signals. Other implementations include demodulating the interfering signal and utilising the demodulation information to neutralise the effects of blocking signals. Examples of the foregoing are described in: U.S. Pat. No. 4,191,926 issued to Pontano et al. on 4 Mar. 1980; U.S. Pat. No. 4,222,051 issued to Kretschmer, Jr. et al. on 9 Sep. 1980; U.S. Pat. No. 4,736,455 issued to Matsue et al. on 5 Apr. 1988; and U.S. Pat. No. 4,384,366 issued to Kaitsuka on 17 May 1983. Any leakage from the transmitter side of a transceiver is cancelled out by extracting a sample of the interfering signal from a coupled signal path of the transmitter and cancelling it out from the incoming received signal after suitable phase detection and adjustments, as described in U.S. Pat. No. 4,660,042 issued to Ekstrom on 21 Apr. 1987.

Alternatively as reported in U.S. Pat. No. 6,169,912 issued to Zuckerman on 2 Jan. 2001, the interfering transmit band signal is extracted from the receive signal itself and used to cancel the interference from the received signal. This type of processing requires some kind of filtering to extract a transmit band signal and is not suitable for suppressing blocking signals that are present in the receive frequency band itself.

The effects of blocking signals on actual information data can be cancelled out in the baseband after data demodulation, as described in U.S. Pat. No. 4,412,341 issued to Geisho et al. on 25 Oct. 1983.

Interference can also be cancelled after elaborately classifying the interference and then mitigating the interference's effects through targeted interference cancellation, as described in U.S. Pat. No. 6,131,013 issued to Bergstrom et al. on 10 Oct. 2000. Though few of these systems are robust, these systems are much easier, or only possible, to implement in the digital domain. This requires high dynamic range ADCs to digitize the signals along with the blocking signals before such processing can be done.

U.S. Pat. No. 3,963,990 issued to Di Fonzo on 15 Jun. 1976 describes cross coupling of signals from two different channels in frequency reuse systems to reduce the interference. However, cross coupling is mainly for interference from channels operating in same frequency but channelized in different polarization angles, and basically not for interference from different frequencies.

U.S. Pat. No. 6,211,671 issued to Shattil on 3 Apr. 2001 interference cancellation schemes for electromagnetic shielding of electromagnetic pickups, other types of electronic equipment, and specific regions of space. This kind of scheme is not suitable for cancelling out blocking signals, as this scheme relies on phase changes in the pickups at different regions in a receiver to effectively cancel out the interference.

Apart from all the cancellation schemes of the incoming blocking signals, this problem may be solved by “near perfect” digital filtering. Several of the foregoing documents have reported improving the dynamic range of the ADCs, so that these signals can be digitized on whole and the required filtering performed to satisfy the blocking tests. However, all of these schemes are disadvantageously complex and consume more power, which are major drawbacks for implementing such schemes in handset kind of applications. Thus, a need clearly exists for an improved technique to reduce interference in receiver architectures of radio communication systems.

### SUMMARY

In accordance with a first aspect of the invention, there is provided a receiver downconversion architecture for attenuating in an input radiofrequency (RF) signal interfering/blocking signals at offset frequencies from a desired signal. The receiver architecture comprises a delay element having a delay that is dependent on an offset frequency of an interfering signal, and an adder for summing the delayed and instantaneous versions of the input signal.

In accordance with a second aspect of the invention, there is provided a method for, in a receiver downconversion architecture, attenuating in an input radiofrequency (RF) signal interfering/blocking signals at offset frequencies from a desired signal. The method comprising the steps of delaying the input signal dependent on an offset frequency of an interfering signal, and adding delayed and instantaneous versions of the input signal to cancel the interfering/blocking signals.

### BRIEF DESCRIPTION OF THE DRAWINGS

A small number of embodiments are described hereinafter with reference to the drawings, in which:

FIG. 1 is a block diagram illustrating a conventional, general receiver architecture;

FIG. 2 is a block diagram illustrating a receiver architecture in accordance with an embodiment of the invention for direct conversion with an image reject mixer for very low IF requiring two ADCs;

FIG. 3A is a spectral graph illustrating the spectrum of an incoming RF signal with a desired signal at frequency RF and blocking/interfering signals at frequencies RF±Δf, RF±2Δf, and so on;

FIG. 3B is a spectral graph illustrating the spectrum of a downconverted signal with the desired signal at ΔF, its image at Δf at a higher signal level, and blocking/interfering signals at 0, 2Δf, 3Δf, and so on;

FIG. 4A is a block diagram illustrating a receiver architecture in accordance with a further embodiment of the invention, which is implemented at IF frequencies for a super-heterodyne receiver architecture;

FIG. 4B is a spectral graph illustrating the spectrum of the downconverted IF signal with the desired signal at IF and blocking/interfering signals at IF±Δf, IF±2Δf, and so on;

FIG. 5 is a spectral graph illustrating phase variation against frequency (through the T_{d} delay);

FIG. 6A is a block diagram illustrating a receiver architecture in accordance with another embodiment of the invention for direct conversion with an image reject mixer for very low IF requiring two ADCs;

FIG. 6B is a block diagram illustrating another receiver architecture in accordance with a further embodiment of the invention, similar to that of FIG. 6A, requiring 3 ADCs instead of two;

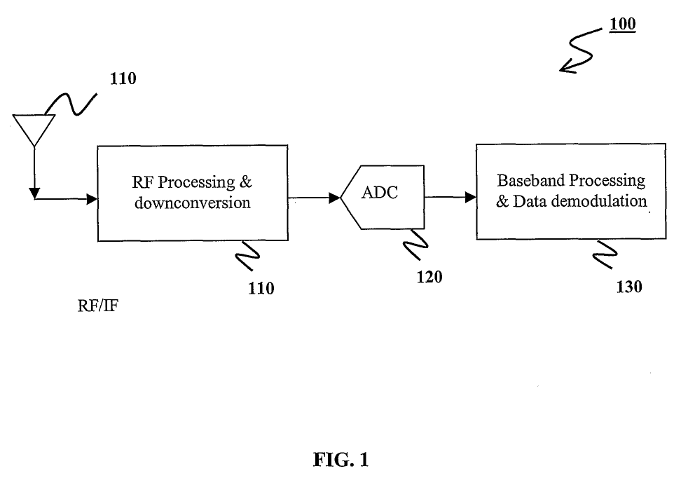

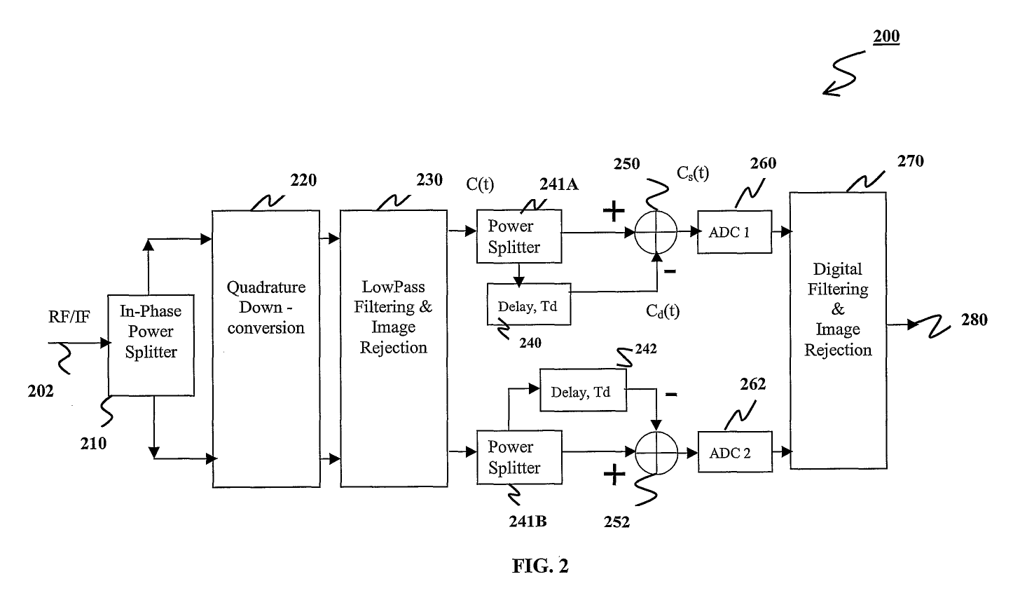

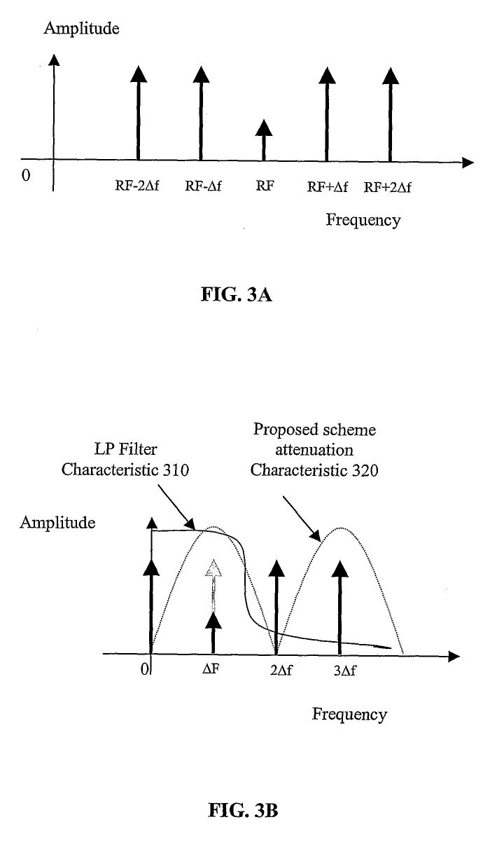

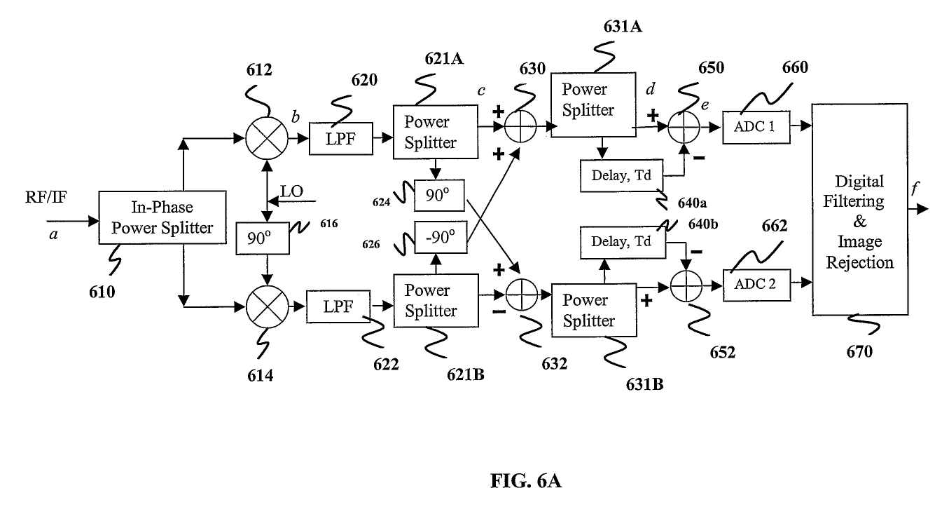

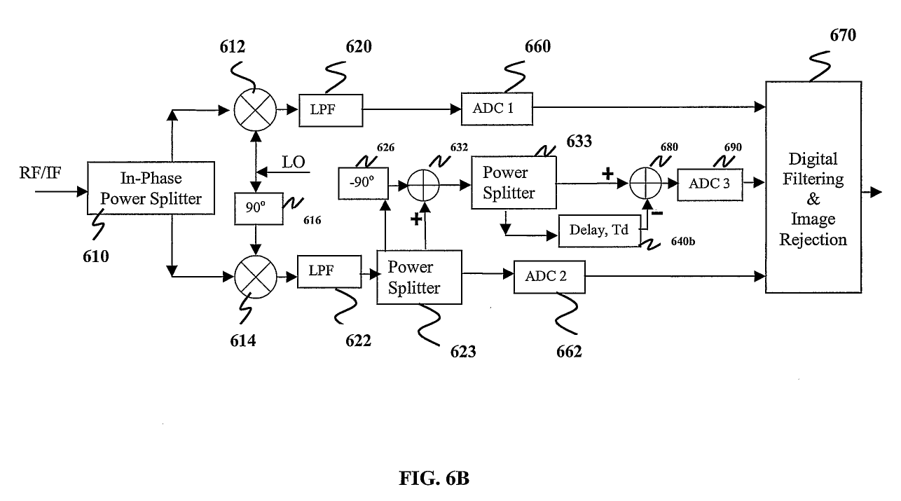

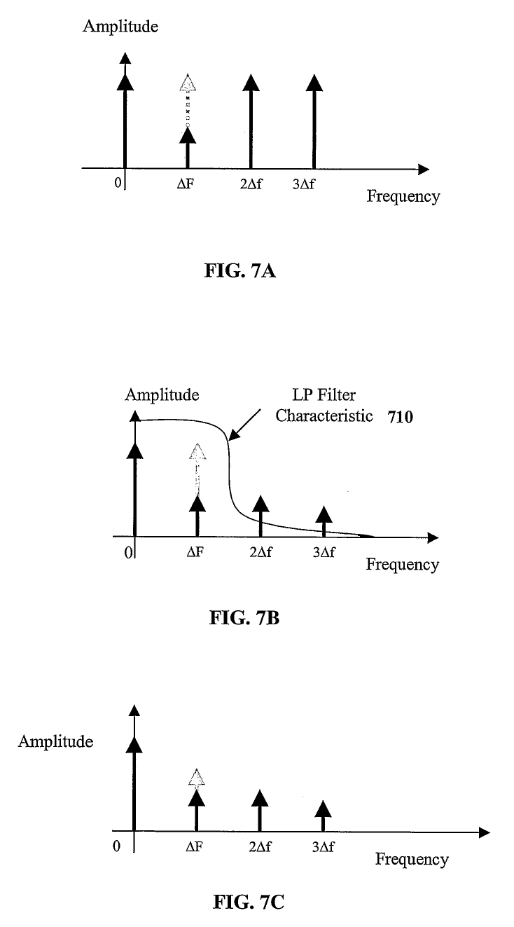

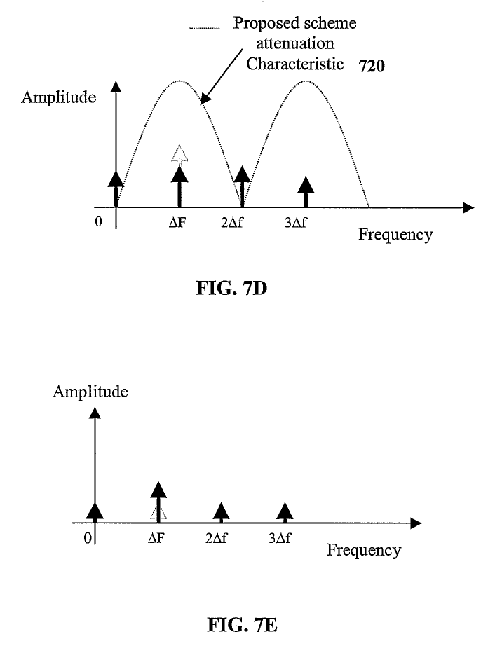

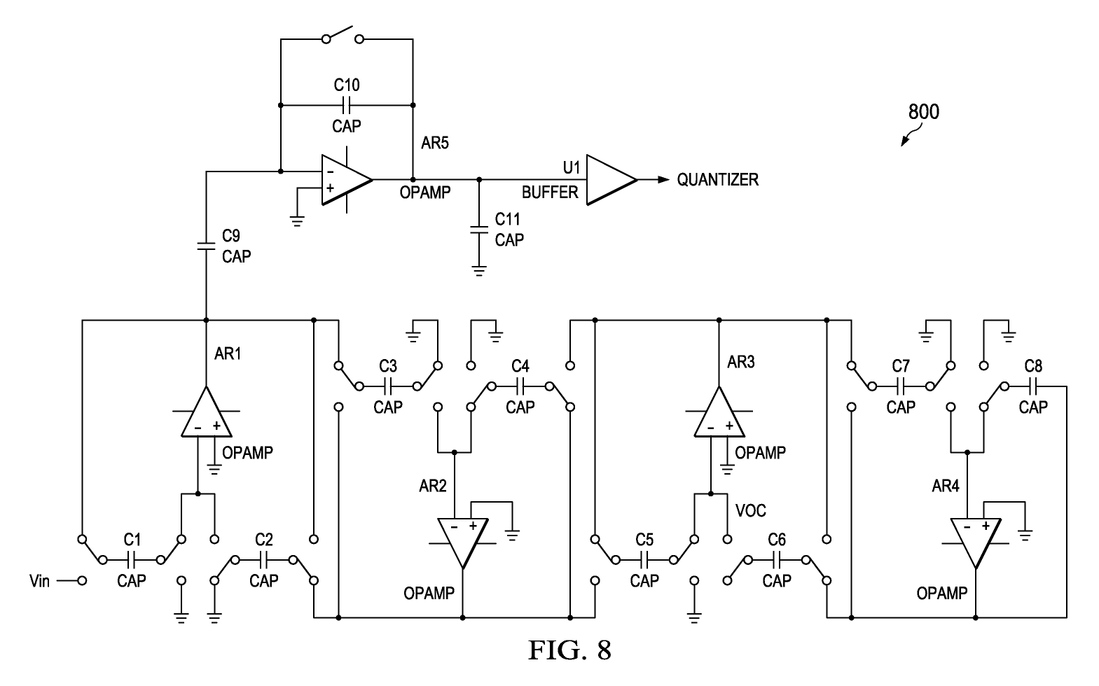

FIG. 3A is a spectral graph of the spectrum of an RF/IF signal at point “a” of FIG. 6A, with the spectrum containing the required signal at RF and blocking/interfering signals at RF±Δf, RF±2Δf, and so on;

FIG. 7A is a spectral graph of the downconverted RF/IF signal spectrum at point “b” in FIG. 6A;

FIG. 7B is a spectral graph of the downconverted RF/IF spectrum after filtering at point “c” in FIG. 6A;

FIG. 7C is the spectral graph of the downconverted, filtered signal after phase shifting and combining with the in-phase downconverted signal at point “d” in FIG. 6A;

FIG. 7D is a spectral graph of the image suppressed signal that is delayed and combined with the feed-through signal at point “e” in FIG. 6A;

FIG. 7E is a spectral graph of the interference and image cancelled signal that is digitised and further filtered and baseband processed; and

FIG. 8 is a schematic diagram of a switched-capacitor delay line and summer configuration in accordance with a further embodiment of the invention.

### DETAILED DESCRIPTION

A multi-mode receiver/downconverter architecture for use with narrow channel bandwidth and wide channel bandwidth system signals is described. In this architecture, interfering signals for a selected narrowband channel are attenuated using a technique that reduces the dynamic range of the signal for further processing. The technique can be used with receiver architectures, such as direct-conversion, low IF, super heterodyne, and the like. In this technique, the downconverted signal is split into two paths. One signal path is delayed and subtracted from the signal from the other path. By controlling the delay value, the interference signals at a given offset are attenuated. Based on the chosen architecture, the desired signal is placed so that the desired signal undergoes minimum distortion.

The embodiments of the invention attenuate the interfering signals for narrowband systems, which otherwise pass through a wider bandwidth baseband/IF filter catering for the wider bandwidth signals sufficiently enough to reduce the dynamic range requirements of ADCs in the receive chain.

FIG. 2 is a block diagram showing a direct-conversion type of receiver architecture 200. An RF/IF signal 202 is input to an in-phase power splitter 210. Two signals are provided to a quadrature down-conversion circuit 220, which provides two outputs to low pass filtering and image rejection circuit 230. A signal C(t) output by the circuit 230 is split by the power splitter 241A and provided to a summer 250 and a delay module 240, which has a delay T_{d}. A delayed signal C_{d}(t) is provided to a negative input of the summer 250. The summer 250 outputs the resulting signal Cₛ(t) to a first ADC module 260. The output of this ADC 260 is provided to digital filtering and image rejection circuit 270. A completely equivalent circuit comprising delay 242, summer 252 and ADC 262 is coupled between the other output of the low pass filtering and image rejection circuit 230 and the other input of digital filtering and image rejection circuit 270. An output signal 280 is produced from circuit 270. Thus, the downconverted I & Q signals are split into two paths each using power splitters 241A & 241B. One path in each branch is delayed 240, 242 and fed forward and subtracted 250, 252 from the undelayed path as shown in FIG. 2.

The narrowband signal is quadrature downconverted using an image reject mixer such that desired signal is positioned at a frequency ΔF and it falls at the upper edge of the much wider baseband filter 310 as shown in FIGS. 3A and 3B. In particular, FIG. 3A illustrates the spectrum of the incoming RF signal, and FIG. 3B shows the downconverted signal with the desired signal, its image, and blocking/interfering signals. The blocking signals on the lower side of the signals fall close to the DC value. The image signal is superimposed on the desired signal. The upper side blocking signals at 2ΔF, 3ΔF, and so on are cut-off by the filter bandwidth roll off 310, as shown in FIG. 3B. The attenuation characteristic for this embodiment is shown with a dotted line in FIG. 3B.

A simple way to calculate the amount of delay to be introduced for addition or subtraction of the signals is described hereinafter. Assuming that the information signal is a phase-shift key (PSK) signal S(t) and the interfering/blocking signal is also a PSK signal X(t), the signals can be written

S(t)=A cos [ω_{c}t+φ_{c}(t)],

X(t)=B cos [ωᵢt+φᵢ(t)],

where: φ_{c}(t) and φᵢ(t) are the instantaneous phases;

ω_{c}=2πf_{c}; f_{c} is the required channel carrier frequency;

ωᵢ=2πfᵢ; fᵢ is the interfering channel carrier frequency;

fᵢ=f_{c}+Δf; and Δf is the offset of the interfering signal from the desired signal frequency.

### In FIG. 2,

C(t)=S(t)+X(t), and

C_{d}(t)=C(t−T_{d}).

Assuming that the delay T_{d} is small enough, the phase φ_{c}(t−T_{d}) and φᵢ(t−T_{d}) can be approximated to φ_{c}(t) and φᵢ(t).

In Cₛ(t)=C(t)−C_{d}(t), the information signal adds up and the interfering signal is cancelled out, if:

T_{d}=1/(2*Δf); and

f_{c}=a*Δf; a=1, 3, 5, 7, . . . (‘a’ is an odd integer).

This relationship is valid for direct downconversion, low IF downconversion and the conventional Super heterodyne architecture using higher IF. Importantly the relationship between the carrier frequency and the offset frequency of the interfering signal requiring maximum cancellation is that the carrier frequency should be an odd multiple of the offset frequency of the interference. So that the required signal undergoes 180° phase shift and the interfering signal is phase shifted by zero or multiples 360° phase shift. When the delayed and feed forward paths are subtracted the 180° phase shifted carrier adds up and the other interfering signal cancels out. The scheme can be modified to use a summer instead of a subtractor, in which case the interfering signal will be phase shifted by 180° and the required signal by zero or multiples of 360°.

From the above analysis, by controlling the delay (equal to 1/(2*Δf)) in the feed forward path, the unwanted blocking signals can be cancelled out or attenuated, and the required signals can be added up. The amount of cancellation depends on the amount of phase shift the fixed delay line imparts to the signals and how far the amplitudes of the delayed and instantaneous signals are matched. The amount of cancellation can be quantitatively calculated based on the amplitude and phase error in the two paths. This is also true for instantaneous frequency components in the signal spectrum. For the required signal not to be distorted, the delay has to be sufficiently less than the inverse of the bandwidth of the data modulated on to the required carrier. The delay can be implemented as a fixed delay element for a particular offset frequency to be cancelled or can be made a programmable delay that can be varied to cancel signals at a particular offset. FIG. 5 shows the phase variations of the signals with different frequencies, when delayed by T_{d}.

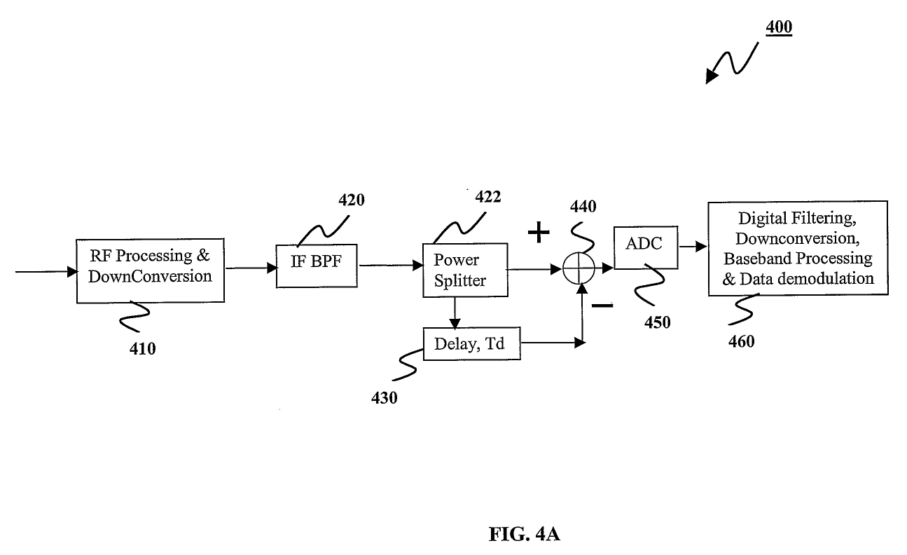

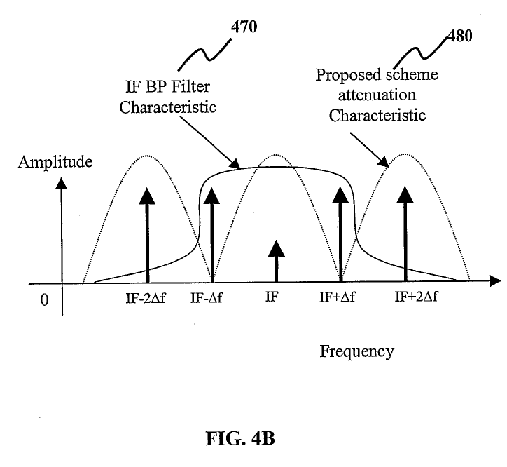

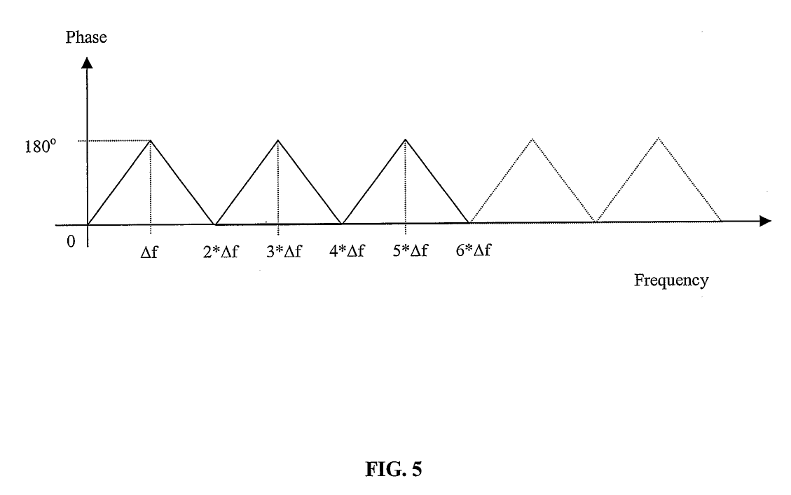

FIG. 4 shows another embodiment of the invention implemented at IF frequency for a Super-Heterodyne receiver architecture. The receiver architecture 400 of FIG. 4A includes an RF processing and downconversion circuit 410, an IF band pass filter 420, a power splitter 422, a delay module 430, an ADC 450, and a digital filtering, downconversion, baseband processing, and data demodulation circuit 460. The output of the circuit 410 is coupled to the input of the bandpass filter 420. The output of the bandpass filter 420 is split using power splitter 422 and provided to a positive input of summer 440 and the delay circuit 430, which provides the delay T_{d}. The output of the delay circuit 430 is provided to a negative input of the summer 440. The output of the summer 440 is provided to the ADC 450. In turn, the output of the ADC 450 is provided to the circuit 460.

In this case, the desired signal is downconverted to the IF frequency and the interfering signals at both sides of the IF frequency are attenuated. Depending on the amount of phase shift the delay introduces to the signals, the signals are cancelled or added up.

In the case of the super-heterodyne downconversion architecture, the splitter, delay and subtraction technique (430, 440) is implemented after the IF Bandpass filter (420), which cuts off the far off blocking signals. Depending on the offset frequency of the interfering signal, the fixed/variable delay value T_{d} is calculated. The IF frequency also has to be fixed in such a way that this frequency satisfies the above mentioned conditions.

FIG. 3A illustrates the spectrum of the incoming RF signal received at the input of the circuit 410, with the desired signal at frequency RF and blocking/interfering signals at RF±Δf, RF±2Δf, and so on. FIG. 4B illustrates the spectrum of the downconverted IF signal with the desired signal at frequency IF and blocking/interfering signals at IF±1Δf, IF±2Δf, and so on. FIG. 4B illustrates the IF bandpass filter characteristic 470 provided by bandpass filter 420 in FIG. 4A. Also shown with dotted lines are the attenuation characteristics 480 provided by this technique. The interference/blocking signals within the baseband filter's passband are attenuated by the attenuation characteristic 480. The interference/blocking signals outside the passband are attenuated by the BPF characteristic 470.

In the case of quadrature direct downconversion scheme, there is a problem of the image signal, which overlaps with the required signal after downconversion. If the offset frequency is based on the blocking signal, the image frequency signal may be a blocking signal of the narrowband system and be of much higher magnitude than the required signal level. This image frequency has to be removed before any further processing and can be removed by using a image reject mixer architecture.

FIG. 6A is a block diagram of a receiver architecture utilising direct conversion with image reject for very low IF utilising two ADCs. The RF/IF signal is provided at point “a” as input to the in-phase power splitter 610. The splitter 610 provides respective outputs to mixers 612 and 614. A local oscillator (LO) provides another input directly to the mixer 612, and a 90° phase delayed signal, produced by the delay element 616, to the other mixer 614. The output of mixer 612 is labelled point “b” and provided to low pass filter 620. Likewise, the output of mixer 614 is provided to low pass filter 622. The output of low pass filter 620 and splitter 621A is labelled point “c” and provided to the summer 630 and 90° phase shifter 624. Similarly, the output of low pass filter 622 is split using splitter 621B and provided to a positive input of summer 632 and a −90° phase shifter 626. The outputs of phase shifters 624 and 626 are provided to respective inputs of summers 630 and 632. The output of the summer 630 is split using splitter 631A and labelled point “d” and provided as input to summer 650 and delay element 640a. The output of delay element 640a, which provides delay T_{d}, is provided to the negative input of a summer 650. Likewise, the output of summer 632 is split using splitter 631B and provided as input to summer 652 and a delay element 640b. The output of delay element 640b is provided to a negative input of the summer 652. The output of the summer 650 is labelled point “e” and provided to an ADC 660. Likewise, the output of the summer 652 is provided to an ADC 662. The outputs of ADCs 660 and 662 are provided to digital filtering and image rejection module 670. The output of module 670 is labelled point “f”.

FIG. 6B is a block diagram illustrating a further embodiment of the invention involving direct conversion with image reject for very low IF requiring three ADCs. The configuration of this circuit is the same as that of FIG. 6A in relation to elements 610, 612, 614, 616, 620, 622 and 623. The output of the power splitter 623 is provided as input to 90° phase shifter 626, a positive input of a summer 632, and another positive input of the summer 632 is fed with quadrature downconverted signal to cancel the image frequency and extract the required signal. The extracted required signal is provided to the delay element 640B which provides delay T_{d}. When the delayed and the feed forward paths are subtracted 680, the interfering signal cancels out depending on the delay T_{d}. This signal is digitised by ADC 690 and provided to module Digital Filtering and Image Rejection module 670. The outputs of low pass filters 620 and power splitter 623 are passed directly to the ADCs 660 & 662, which provide outputs to the digital filtering and image rejection module 670. In the module 670, the required signal is filtered and Image signal is further cancelled/attenuated by standard filtering and image cancellation techniques.

FIGS. 7A-7E show signal spectrum at different stages of the circuit FIG. 6A

FIG. 7A illustrates the downconverted RF/IF signal spectrum at point “b” of FIG. 6A. The spectrum is shifted to the baseband with the required signal at Δf and the blocking/interfering signals at 0, 2Δf, 3Δf, and so on. In the spectral graph, the image signal is seen overlapping the required signal at frequency Δf.

FIG. 7B is a spectral graph illustrating the spectrum at point “c” of FIG. 6A. The low pass filter characteristic 710 of low pass filter 620 is shown. The downconverted RF/IF signal spectrum is filtered for sum components and other interferences. The spectrum has the blocking/interfering signals at 2Δf, 3Δf, and so on, attenuated by the low pass filter characteristic 710. The blocking/interfering signals at frequency 0 and the image signal overlapping on the desired signal at frequency Δf are still significant.

FIG. 7C is a spectral graph of the signal spectrum at point “d” of FIG. 6A. The downconverted, filtered signal is 90° phase shifted and combined with an in-phase downconverted signal. The spectrum has the image signal (overlapping on the required signal at frequency Δf) significantly attenuated.

FIG. 7D is a spectral graph illustrating the spectrum at point “e” of FIG. 6A. The image suppressed signal is delayed and combined with the feed-through signal at ΔF, which attenuates the interfering signal at frequency 0. FIG. 7D illustrates the proposed attenuation characteristic 720. The amount of attenuation depends on the phase shift provided by the delay element 640A. The spectrum shown has the image signal (overlapping on the required signal at frequency Δf) and the interfering signal at frequency 0 attenuated.

The module 670 provides at its output the signal at point F of FIG. 6A. FIG. 7E is a spectral graph illustrating the interference and image cancelled signal that is digitised and further filtered and baseband processed. This is done to attenuate the interfering signal at frequency 0 and the image signal (overlapping on the required signal at frequency Δf). After this, the required signal at frequency Δf can be further digitally downconverted for further processing.

The use of image reject mixer architecture may not attenuate the image frequency completely and depends on the 90 degree hybrid used to combine the quadrature down converted signal and the signal path lengths after downconversion. As the proposed technique may be used for narrowband signals, the 90 degree hybrid meeting the requirements in the narrow band of interest is sufficient. The attenuation of the blocking/interfering signals leads to the reduction in the dynamic range requirements of the ADC for digitisation and subsequent processing of the multi-mode signals.

The delay T_{d} can be implemented in many ways, examples of which are listed below.

One method uses a simple length of cable or a transmission line having an electrical length that is adjusted so that the cable gives the required delay as calculated above for the required offset frequency. The length of cable can be numerically estimated based on the velocity of electromagnetic (EM) waves in the material in which cable is realised.

Another method integrates the delay into the A/D conversion process. Once the signal is sampled and held, the signal can be split into two paths. One path can be delayed using switched capacitor circuits and combined with the main path samples before quantization. By this way, the limitations on the sample and hold amplifier remain, but the quantizer sees attenuated levels of the blocking signals. The quantizations levels in the quantizer can be set to maximise the dynamic range with reduced number of bits and suitable gain amplifiers can be used to maximise the use of the dynamic range of the quantizer. FIG. 8 shows a typical example of an implementation using switched capacitor techniques. The switched capacitor delay line when implemented can be made to give a different values of delay depending on the clock frequencies used to turn ON and OFF the switches and the number of unit delay stages used. A more detailed description on the working of the circuit is given in Eriksson, S., “Realisation of Switched capacitor delay lines and Hilbert transformers”, Electronics Letters, July 1991, Vol 27, No 14, pp 1262-1263.

Thus, a multimode receiver/downconverter architecture has been described. While only a small number of embodiments have been described, it will be apparent to those skilled in the art that, in the light of this disclosure, modifications and variations can be made without departing from the scope and spirit of the invention.

1. A receiver downconversion architecture for attenuating in an input radiofrequency (RF) signal interfering/blocking signals at offset frequencies from a desired signal, said receiver architecture comprising:
a delay element having a delay that is dependent on an offset frequency of an interfering signal; and
an adder for summing/subtracting delayed and instantaneous versions of said input signal based on the phase relationship between the signals.

2. The receiver downconversion architecture as claimed in claim 1, wherein said cancellation results in undesired signals in said input signal being attenuated such that dynamic range requirements for analog-to-digital conversion are reduced.

3. The receiver downconversion architecture as claimed in claim 1, further comprising means for modifying a direct-conversion architecture to offset said desired signal by an offset frequency at least approximate to a frequency offset of at least one critical interfering signal.

4. The receiver downconversion architecture as claimed in claim 1, wherein said delay is equal to T_{d}=1/(2*Δf), where Δf is equal to said frequency offset of said at least one critical interfering signal relative to said desired signal.

5. The receiver downconversion architecture as claimed in claim 1, wherein said delay element is implemented using transmission lines.

6. The receiver downconversion architecture as claimed in claim 1, wherein said delay and said adder are implemented using switched capacitor and operational amplifiers.

7. The receiver downconversion architecture as claimed in claim 1, wherein said delay and said adder are integrated with a frontend of an analog-to-digital converter (ADC).

8. The receiver downconversion architecture as claimed in claim 1, further comprising means for converting said desired signal to an intermediate frequency (IF) equal to an odd multiple of Δf=1/(2*T_{d}), where T_{d} is said delay of said delay element.

9. The receiver downconversion architecture as claimed in claim 1, wherein said delay element is programmable.

10. The receiver downconversion architecture as claimed in claim 1, further including a Low Frequency intermediate frequency (IF)/Zero IF architecture.

11. The receiver downconversion architecture as claimed in claim 10, further comprising a mixer, where said desired signal is consequently positioned at an upper end of a low pass spectrum.

12. The receiver downconversion architecture as claimed in claim 1, comprising a Super Heterodyne architecture with an intermediate frequency (IF) equal to an odd multiple of a frequency offset with interference.

13. A method for, in a receiver downconversion architecture, attenuating in an input radiofrequency (RF) signal interfering/blocking signals at offset frequencies from a desired signal, said method comprising the steps of:
delaying said input signal dependent on an offset frequency of an interfering signal; and
adding delayed and instantaneous versions of said input signal to cancel said interfering/blocking signals.

14. The method as claimed in claim 13, wherein said cancellation results in undesired signals in said input signal being attenuated such that dynamic range requirements for analog-to-digital conversion are reduced.

15. The method as claimed in claim 13, further including the step of modifying operation of a direct-conversion architecture to offset said desired signal by an offset frequency at least approximate to a frequency offset of at least one critical interfering signal.

16. The method as claimed in claim 13, wherein a delay generated by said delaying step is equal to T_{d}=1/(2*Δf), where Δf is equal to said frequency offset of said at least one critical interfering signal relative to said desired signal.

17. The method as claimed in claim 13, wherein said delaying step is implemented using transmission lines.

18. The method as claimed in claim 13, wherein said delaying and said adding steps are implemented using switched capacitor and operational amplifiers.

19. The method as claimed in claim 13, wherein said delaying and said adding are implemented with circuitry integrated with a frontend of an analog-to-digital converter (ADC).

20. The method as claimed in claim 13, further including the step of converting said desired signal to an intermediate frequency (IF) equal to an odd multiple of Δf=1/(2*T_{d}), where T_{d} is said delay of said delay element.

21. The method as claimed in claim 13, wherein a delay generated by said delaying step is programmable.

22. The method as claimed in claim 13, wherein said receiver downconversion architecture includes a Low Frequency intermediate frequency (IF)/Zero IF architecture.

23. The method as claimed in claim 22, further including the step of mixing so that said desired signal is consequently positioned at an upper end of a low pass spectrum.

24. The method as claimed in claim 13, wherein said receiver downconversion architecture comprises a Super Heterodyne architecture with an intermediate frequency (IF) equal to an odd multiple of a frequency offset with interference.
